(19) United States
(12) Patent Application Publication
(10) Pub. No.: US 2011/0293093 A1
(43) Pub. Date: Dec. 1, 2011

(54) METHOD AND SYSTEM FOR IDENTITY-BASED KEY MANAGEMENT

(75) Inventors: Sheng SUN, Kanata (CA); Barry PRATT, Brampton (CA); Sandip SINGH, Brampton (CA); Antonio COLANTONIO, Mississauga (CA)

(73) Assignee: ROGERS COMMUNICATIONS INC., Toronto (CA)

(21) Appl. No.: 12/791,113

(22) Filed: Jun. 1, 2010

(51) Int. Cl. H04L 9/08; H04L 9/00; H04N 7/167

(52) U.S. Cl. 380/211; 380/279; 380/44

(57) ABSTRACT

Systems, methods and devices for distributing a group key between a transmitter and a group of receivers connected over a network. The described group key distribution can be implemented in any television network for encrypted transmission of television related content to large and dynamic groups of subscribers' receivers. Wherein each receiver contributes to the group key by securely transmitting its contribution to the transmitter. The transmitter also contributes to the group key and generates the group key based on all contributions. The transmitter further generates partial keys specific to each receiver such that each receiver can generate a copy of the group key from its contribution and the partial key it receives. The transmitter sends each receiver its corresponding partial key so that each receiver can calculate a copy of the group key.

### FIELD

The present application generally relates to cryptography and, in particular, to methods and systems for distributing a group key for encrypted communications.

### BACKGROUND

Distributing a group key amongst a group involves computational overhead and consumption of network resources that can increase exponentially when the size of the group increases or when the group composition changes dynamically.

Group key distribution designates the process and methodology of sharing a set of secret keys for encryption or integrity protection purpose amongst a certain number of group participants in a secured way.

Group key distribution amongst multiple devices attempting to communicate securely with each other in a mesh topology scales poorly because each device would need to maintain key material from all the devices participating in the group. In a hub and spoke topology, all communications traverse back to a central hub that decrypts and encrypts information for all devices in the group. In such systems the hub requires exponentially increasing computing power as the group size increases. Other group key distribution methods may rely on connectivity between devices in a ring structure passing key material from one subscriber to the next in the ring. In these systems key distribution is burdensome when the group composition changes dynamically.

Efficient group key distribution amongst large and dynamic groups of subscribers is important in the context of consuming real-time multimedia content. For example, television providers control content access for a large and potentially dynamic group of subscribers to broadcast multi-media content. The multi-media content can include, for example, various basic television channels, specialty channels, pay-per-view content, video-on-demand and other television content, some of which may be viewed or consumed on a “group” basis. Television providers employ Conditional Access Service (CAS) and Digital Rights Management (DRM) solutions as well as Integrated Receiver/Decoders (IRDs) to restrict access to the content they provide to their subscribers. Content restriction has been achieved by providing the subscriber with a receiver such as a set top box (STB) or a set top unit (STU) through which television content is decoded for viewing. Existing receivers have been simplified devices arranged in a tree topology for security establishment. They have limited uplink capacity and rely on the television provider to generate and distribute encryption keys to each individual receiver. Consequently, increasing the number of receivers or dealing with complex dynamic groups of receivers places significant burden on the centralized transmitters operated by television providers.

It would be advantageous to provide for a device, system and method that more efficiently addresses group key distribution for large and dynamic group sizes.

### BRIEF DESCRIPTION OF THE DRAWINGS

Reference will now be made, by way of example, to the accompanying drawings which show example embodiments of the present application, and in which:

FIG. 1A is a system diagram including embodiments of the present disclosure;

FIG. 1B is a television network diagram including further embodiments of the present disclosure;

FIG. 1C is a system diagram mathematically describing an embodiment of the present disclosure;

FIG. 2 is a component plan for a transmitter device of the present disclosure;

FIG. 3 is a component plan for a receiver device of the present disclosure;

FIG. 4 is a flowchart illustrating a general process of group key distribution in accordance with an example embodiment of the present invention; and

FIG. 5 is a processing and message sequence diagram in accordance with an example embodiment of the present disclosure.

Similar reference numerals may have been used in different figures to denote similar components.

### DESCRIPTION OF EXAMPLE EMBODIMENTS

The present disclosure describes devices, methods and systems for distributing a group key for encrypted transmission of multi-media content in large and dynamic groups.

In one embodiment, the present application describes a method for distributing a cryptology key between a transmitter and a group of two or more receivers. The method comprises providing a transmitter connected to each receiver of the group of two or more receivers via a network. Receiving, from each receiver, receiver key material containing an encrypted receiver contribution. Decrypting, from each receiver key material, the receiver contribution of that receiver. Calculating a group key based on a transmitter contribution and the receiver contribution of each receiver. Generating, for each receiver, a partial key by excluding that receiver's receiver key material from the group key. And distributing, to each receiver, the partial key corresponding to that receiver via the network. Consequently, combining each receiver's partial key with that receiver's receiver contribution generates the group key which can be used to encrypt and decrypt transmitted content.

In another embodiment, the present disclosure describes a device comprising a processor, a memory and an application stored in memory and containing instructions for configuring the processor to distribute a group key between the device and a group of two or more receivers. The processor is configured to generate a device contribution unique to the device, receive key material from each receiver in the group, decrypt a receiver contribution from each receiver's key material, and generate the group key based on the device contribution and the receiver contribution of each receiver. The processor is further configured to generate a set of partial keys, one for each receiver, each partial key being based on the group key excluding the receiver contribution of that receiver device whereby each partial key can be combined with the receiver contribution of its corresponding receiver to generate the group key. The device sends each partial key to its corresponding receiver.

In yet another embodiment, the present disclosure describes another device comprising a processor, a memory and an application stored in memory and containing instructions for configuring the processor to distribute a group key between a transmitter and a group of two or more devices including the device. The process is configured to generate a device contribution unique to the device, generate key material by encrypting the device contribution, send the key material to the transmitter, receive a partial key from the transmitter and generate the group key based on the partial key and the device contribution.

In yet a further embodiment, the present disclosure describes a Conditional Access Service (CAS) server for distributing a cryptology key between the CAS server and a group of two or more receiver devices over a network. The CAS server comprises a memory for storing a CAS contribution configured to uniquely identify the CAS server, for storing a group key and for storing a set of partial keys. The CAS server is configured to receive receiver key material from each receiver device via the network. The CAS server includes a receiver contribution decryptor configured to decrypt a receiver contribution of each receiver device from the receiver key material of that receiver device. The decryptor is also configured to store the receiver contribution in the memory. The CAS server also includes a CAS group key generator configured to compute the group key based on the CAS contribution and each of the receiver contributions and configured to store the group key in the memory. A CAS partial key generator is configured to compute the set of partial keys, one for each receiver device. Each partial key is based on the group key excluding the receiver contribution of that receiver device whereby each partial key can be combined with the receiver contribution of its corresponding receiver to generate the group key. The CAS server is configured to transmit each partial key to its corresponding receiver device via the network.

In yet a further embodiment, the present disclosure describes a receiver device for distributing a cryptology key between a transmitter and a group of two or more receiver devices over a network, the group including the receiver device. The receiver device comprises a memory for storing a receiver contribution configured to uniquely identify the receiver device from other receiver devices in the group and a group key. A receiver contribution encryptor is configured to generate receiver key material containing the receiver contribution. The receiver device is configured to transmit the receiver key material to the transmitter via the network, and to receive a partial key from the transmitter via the network. The receiver device includes a receiver group key generator configured to compute the group key based on the receiver contribution and the partial key and configured to store the group key in the memory.

Other aspects and features of the present application will be understood by those of ordinary skill in the art from a review of the following description of examples in conjunction with the accompanying figures.

The following description of specific embodiments may refer to group key distribution and management in the context of broadcast television services, including pay-per-view events or group consumption of an on-demand multi-media offering. However, it will be appreciated that the present application is not necessarily limited to broadcast television networks or services. Although examples embodiments herein may refer to conventional cable television providers and/or networks, the described methods and systems may be applicable more broadly to group consumption of real-time multimedia content on other networks, including wireless networks, IP networks, etc. Accordingly, the “receivers” referred to herein may include a broad range of computing devices, including mobile devices and general purpose computers. The described methods and system may further be applied for purposes other than real-time multi-media content consumption by subscribers. Any communications in which a group of computing devices requires a secret key for encrypting and decrypting communications amongst the group may benefit from the key distribution and management methods and systems described herein.

The following description details embodiments of devices, systems and methods for distributing a group key between a transmitter and a group of two or more receivers over a network. As described in greater detail below, a group key can be distributed when the transmitter receives encrypted group key contributions from each receiver, generates the group key which it maintains secret and a set of partial keys specific to each receiver such that when sent to their respective receivers, each receiver can generate the group key by combining its contribution with its received partial key.

The use of the term “transmitter” and “receiver” in the present description is not intended to indicate that the present application is limited to an architecture in which one transmitting device broadcasts encrypted content to a plurality of passive receiving devices. In some embodiments, the “receivers” engage in encrypted communications amongst each other within the group, using the group key to encrypt and decrypt communications, for example during a conference call or video conference. In some embodiments, the “transmitter” may be a key management device that does not participate in the encrypted communications. In other embodiments, the “transmitter” may be one of the participants in the encrypted communications amongst the group of “receivers”. Other variations and modification will be appreciated by those ordinarily skilled in the art having regard to the description herein.

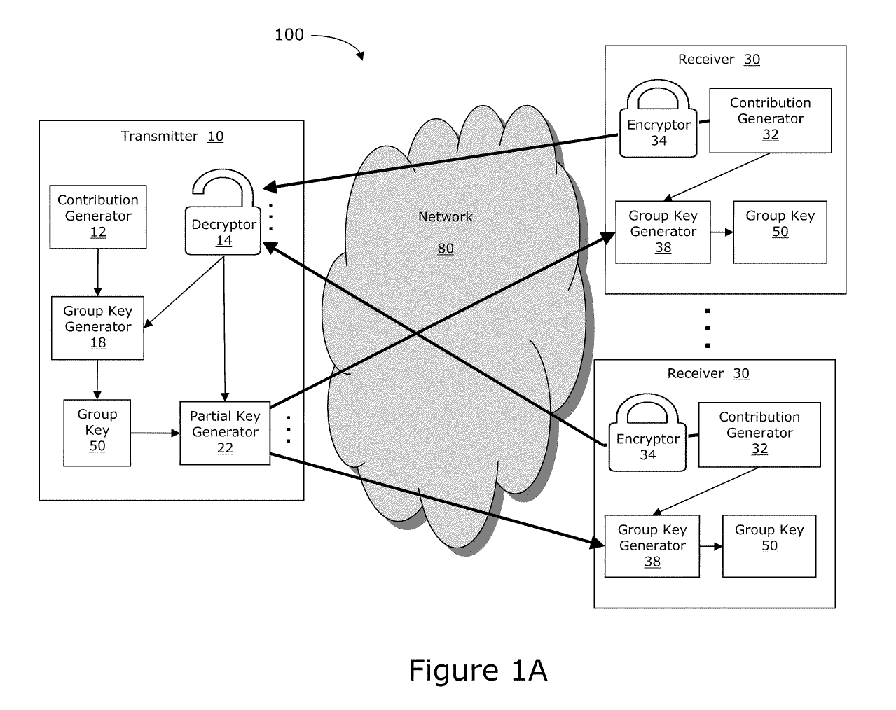

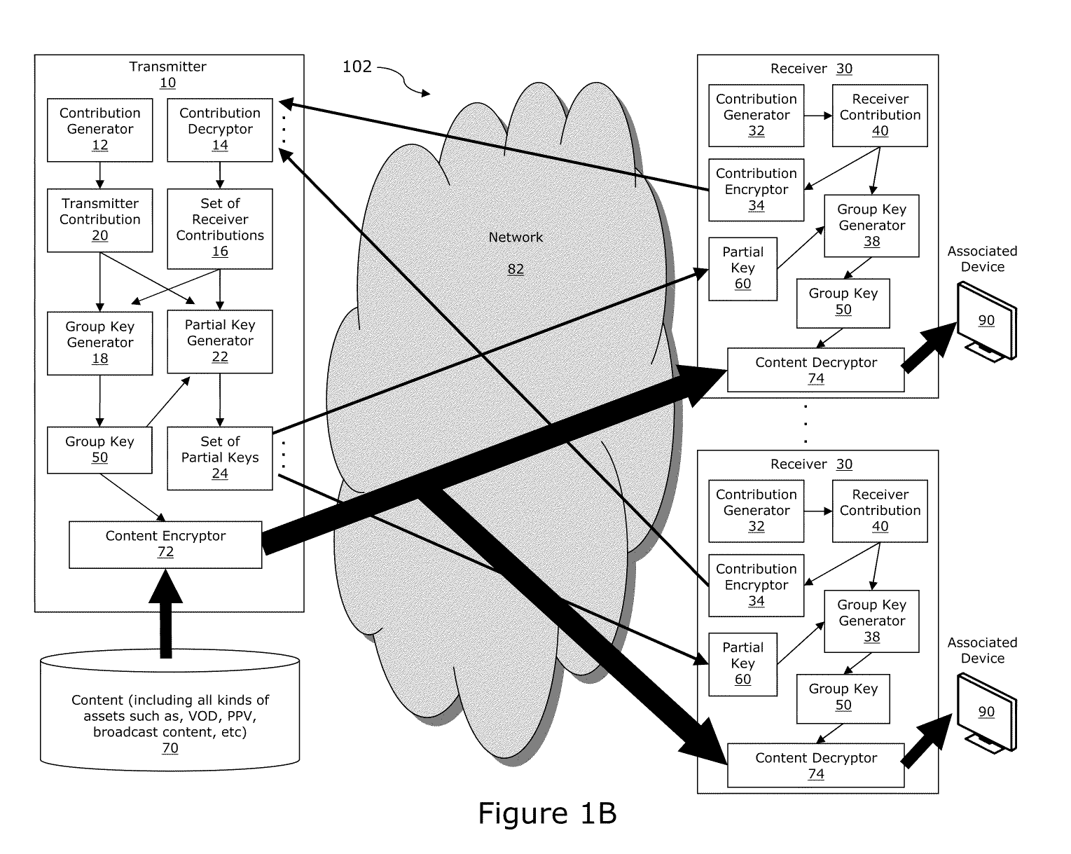

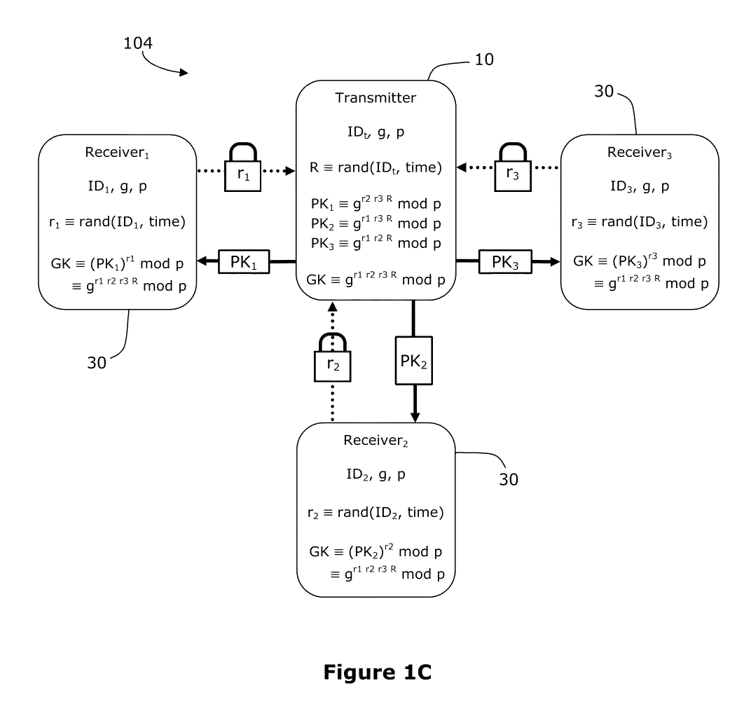

Reference is now made to FIG. 1A which shows a system 100 according to one embodiment of the present disclosure. The group key distribution system 100 is configured to distribute a group key 50 between a transmitter 10 connected to a group of two or more receivers 30 via a network 80. The transmitter 10 may be any type of transmitter device including a reconfigured general purpose computer, a television headend server, a conditional access service (CAS) server, a digital rights management (DRM) server or an integrated receiver/decoder (IRD) for example.

The transmitter 10 comprises a contribution generator 12, a decryptor 14, a group key generator 18 and a partial key generator 22 and a group key 50. The contribution generator produces the transmitter's contribution to the group key 50. This contribution is kept secret by the transmitter 10. The decryptor 14 decrypts key material received from each receiver 30 via network 80 to obtain each receiver's contribution, which is then used in generating the group key 50. The group key generator 18 generates the group key 50 at the transmitter 10 based on all of the contributions received from the group of receivers 30 and the contribution from the transmitter 10. The partial key generator 22 generates a partial key for each receiver 30 based on the group key 50 excluding the contribution of that receiver 30. Each partial key is particular to its corresponding receiver 30 such that the group key 50 can be generated from that partial key and the corresponding receiver's secret contribution.

The receiver 30 in this embodiment may be any type of receiver including a reconfigured general purpose computer, a mobile TV receiver, a television set top box, an internet television set top, an internet protocol television (IPTV) set top unit and an integrated receiver/decoder box, for example. The receiver 30 comprises a contribution generator 32, an encryptor 34, a group key generator 38 and a group key 50. The contribution generator 32 produces the receiver's contribution to the group key 50. This contribution is kept secret by the receiver 30 but securely shared with the transmitter 10. The encryptor 34 encrypts the receiver's contribution so that it can be securely transmitted over the network 80 to the transmitter 10. The group key generator 38 computes a copy of the group key 50 at the receiver 30 by combining a partial key received from the transmitter 10 and the receiver's contribution. In the result, the transmitter 10 and a group of receivers 30 have each contributed to and distributed the group key 50 which can now be used for various encrypted communications.

Contribution generators 12 and 32 of the transmitter 10 and receiver 30 respectively generate a contribution for their respective device. In one example embodiment, the contribution generators 12, 32 comprise a random number generator. The contribution generators 12, 32 may generate the device's contribution based on the device's unique identity (id) and a time stamp. The uniqueness of each contribution may be based on hashing the time stamp and each device's unique identity.

The receiver's encryptor 34 and the transmitter's decryptor 14 can agree to use any method of cryptography known in the art to securely transfer the receiver's contribution over the network 80. For example, the transmitter 10 can comprise a trusted third party that acts as a private key generator in identity-based cryptography. In one embodiment, the transmitter 10 and a receiver 30 can securely exchange the receiver's contribution by using a Diffie-Hellman based encryption protocol.

The group key 50 calculated by the transmitter 10 and each receiver 30 in the group should be maintained secret by each device so that the group key 50 may be used for encrypted transmission of content from one device to all others, such as the transmitter to all receivers. The contributions from each receiver and from the transmitter should be kept secret, while the partial keys may be publicly transmitted over the network so long as calculating the group key from any subset of partial keys, encrypted receiver contributions and other information that would be assumed known to an attacker, remains a hard problem.

It is considered to be a Computational Diffie-Hellman (CDH) hard problem for an attacker to deduce a group key from only one or a few partial group keys with knowledge of the group key distribution protocol. In one example embodiment, instead of directly using the well known public IDs of each member as a contribution to the group key, the contribution is generated by hashing the result of the time of refreshing/registering the group key and the member's public ID, which makes guessing the member's contribution even harder.

The network 80 may be any kind of network including a public network such as the Internet or a private network such as a cable television or a wireless telephony network. The network 80 must permit communication between the transmitter 10 and each receiver 30 of the group.

In operation, the transmitter 10 and each receiver 30 calculate their contributions. Each receiver 30 encrypts its contribution and transmits this key material to the transmitter 10. The transmitter 10 receives key material from each receiver 30 and decrypts each receiver's contribution. The transmitter 10 calculates the group key 50 based on all contributions it has received and its own contribution and it calculates a partial key for each receiver. The transmitter 10 sends each partial key to its respective receiver 30 and each receiver 30 calculates a copy of the group key 50 based on the received partial key and its own contribution. Thereafter, the transmitter and the group of receivers can communicate using the group key for encryption and decryption of content.

When the membership of the group of receivers changes by adding or removing a receiver from the group, the transmitter 10 can generate a revised group key based on a revised set of contributions and distribute new partial keys to each receiver. In another example embodiment, the transmitter 10 can request new contributions from each receiver 30 in the new group and generate a new group key. When revising the group key, the transmitter 10 can combine the new receiver's contribution with the existing set of receiver contributions, or remove the old receiver's contribution from the existing set of receiver contributions. The transmitter may also revise its contribution from time to time, or as necessary when adding or removing a receiver.

FIG. 1B illustrates a group key distribution system 102 according to an embodiment of the invention applied to distribute television content. FIG. 1B also describes in greater detail the operation of the transmitter 10 and the receiver 30.

The transmitter 10 of FIG. 1B is a component of a central control system such as a cable television headend. The transmitter 10 may comprise a conditional access service (CAS) server or a digital rights management (DRM) server, for example. The transmitter 10 comprises a transmitter contribution generator 12, a receiver contribution decryptor 14, a group key generator 18, a partial key generator 22 and a group key 50 as described above in reference to FIG. 1A. The transmitter 10 of FIG. 1B also illustrates the transmitter contribution 20, the set of receiver contributions 16 and the set of partial keys 24 that are maintained by the transmitter 10 as described above in reference to FIG. 1A. The partial key generator 22 may calculate the set of partial keys 24 based on the set of receiver contributions 16, the transmitter contribution 20 and the group key 50. In one embodiment, the partial key for a receiver 30 is determined by removing from the group key 50 that receiver's contribution to the group key 50. In another embodiment, the partial key for a receiver 30 is calculated by combining the transmitter contribution 20 with the set of receiver contributions 16 omitting the receiver contribution of that receiver. Depending on the implementation of the transmitter 10, either method or further methods for determining the set of partial keys can be computationally advantageous.

The transmitter 10 may include a content encryptor 72 for encrypting content 70 with the group key 50 whereafter the encrypted content is distributed to receivers 30 over the network 82. Such distribution may be achieved by another component of the headend independent from the transmitter 10. The content encryptor 72 itself may be a separate component of the headend so long as the group key 50 is not compromised or otherwise made publicly available.

The receiver 30 of FIG. 1B may be any kind of set top box that can be provided to a television subscriber or a component of a mobile television device. The receiver 30 comprises a contribution generator 32, a contribution encryptor 34, a group key generator 38 and a group key 50 as described regarding FIG. 1A. The receiver 30 in FIG. 1B also includes a receiver contribution 40 and a partial key 60 that it maintains, such as within a memory, in the receiver 30. The receiver 30 includes a content decryptor 74 that uses the group key 50 to decrypt encrypted content received through the network 82. The content encryptor 72 and the content decryptor 74 may be implemented in software or in hardware or in a combination thereof. The content encryptor and decryptor 72, 74 may be designed so as to provide real-time access to content to an associated device 90. The associated device 90 may be a television set, a personal computer, a mobile device such as a smart phone or other content consumer device.

The content 70 may be any form of audio and/or visual content or data content relevant to a television network such as an electronic programming guide. Content 70 includes all kinds of assets such as, but not limited to, video on demand (VOD), pay per view (PPV), broadcast content including specialty channels, international content, regional content and public broadcast content. Content 70 includes re-broadcast content and content that is encrypted in other ways for other purposes at the receiver 30.

The network 82 may be a television network such as a cable television network, a satellite television network, a wireless television network, an internet based television network or other television network based on an internet protocol (IP) architecture. The network 82 may be a private network, a public network or a combination of the two.

In practice, an example embodiment such as system 102 permits a cable television provider to distribute content 70 from the provider's central control system including a transmitter 10 to a group of subscribers' receivers 30 over a network 82. The group of receivers 30 may be a subset of the cable television provider's subscribers such that the provider can conditionally and dynamically grant access to content. The provider can regulate which subscribers have access to which content by maintaining multiple groups of receivers each with its own group key and encrypting the content intended for each group with that group's group key. A receiver may be a member of multiple groups and may maintain multiple group keys. The provider may also encrypt content and distribute to subscribers' receivers over a public network such as the Internet.

Turning to FIG. 1C, an example embodiment of the present disclosure illustrates a system 104 as it could be represented in a mathematical context applied to the physical structure previously described in FIGS. 1A and 1B. In system 104, the transmitter 10, three receivers 30 (receiver₁, receiver₂ and receiver₃ respectively) share knowledge of a generator g and a prime number p where g is a generator of the cyclic group G with prime order p. The transmitter 10 and the receivers 30 also agree upon a secure method for the receivers 30 to transmit their receiver contributions r₁, r₂ and r₃ to the transmitter 10. The transmitter 10 and each receiver 30 may have a unique identifier (IDₜ, ID₁, ID₂ and ID₃ respectively). The content generators 12, 32 (shown in FIGS. 1A and 1B) generate contributions (R, r₁, r₂ and r₃) to the group key for the transmitter and each receiver respectively. As shown in system 104, the contributions are generated as a random number that is a function of the device's identity and a time stamp (time); however, any other method of generating a random or pseudo-random contribution to the group key could be used. The receiver contributions r₁, r₂ and r₃ are securely transmitted to the transmitter 10 to compute a set of partial keys, (PK₁, PK₂ and PK₃) one for each receiver and a group key GK. As shown in FIG. 1C, the group key GK is equivalent to the generator g raised to the power of the product of the device contributions R, r₁, r₂ and r₃ modulus p and the partial keys are equivalent to the generator g raised to the power of the product of the contributions excluding the contribution of the receiver that will be sent that partial key. It is emphasized that these mathematical formulae are merely representative of the elements of system 104 such that system 104 is not restricted to computing the group key 50 or the set of partial keys 18 using the formulae recited in FIG. 1C. For non-limiting example, partial key PK/could be computed by raising the group key GK to the power of 1/r₁ or the group key and the partial keys could be computed concurrently such as in the following pseudo-code:

```
GK = PK₁ = PK₂ = PK₃ = g^{R} (mod p)
for (i = 1 to 3)
    GK = GK^{r}^{ᵢ} (mod p)
    for (j = 1 to 3)
        if (j ≠ i) then PKⱼ = PKⱼ^{r}^{ⱼ} (mod p)
    end for j loop
end for i loop
```

Generalized for n receivers in the group, the group key GK can be determined by the transmitter equivalent to the formula:

$$GK = {g}^{R {\prod }_{i = 1}^{n} {g}^{{r}_{i}}} ( mod p )$$

Similarly generalized for the i^{th} receiver in the group of n receivers, the i^{th} partial key PKᵢ can be determined by the transmitter equivalent to the formula:

$${PK}_{i} = {g}^{R {\prod }_{j = 1}^{n , j \neq i} {g}^{{r}_{j}}} ( mod p )$$

After the transmitter 10 calculates the group key GK and the set of partial keys (PK₁, PK₂ and PK₃), the transmitter 10 sends each partial key to its corresponding receiver 30. Because each receiver 30 and the transmitter 10 maintain the contributions secret and because p is generally selected to be a very large prime number, it is considered computationally difficult to determine the individual contributions to each partial key or otherwise determine the group key without knowledge of any individual device's contribution. The example embodiment in system 104 is mathematically similar to the discrete Diffie-Hellman problem where given an element g and the values of g^{x} and g^{y} it is considered to be a hard problem to determine the value of g^{xy}. However, upon receiving a partial key PKᵢ and having kept its contribution rᵢ secret, the i^{th} receiver can calculate the group key equivalent to the following formula:

GK=PKᵢ^{r}_{ⁱ}(mod p)

Once each receiver 30 and the transmitter 10 have calculated the group key GK, content can be encrypted with the group key, transmitted over a network, and any of the receivers to the transmitter will be capable of decrypting the content using its copy of the group key.

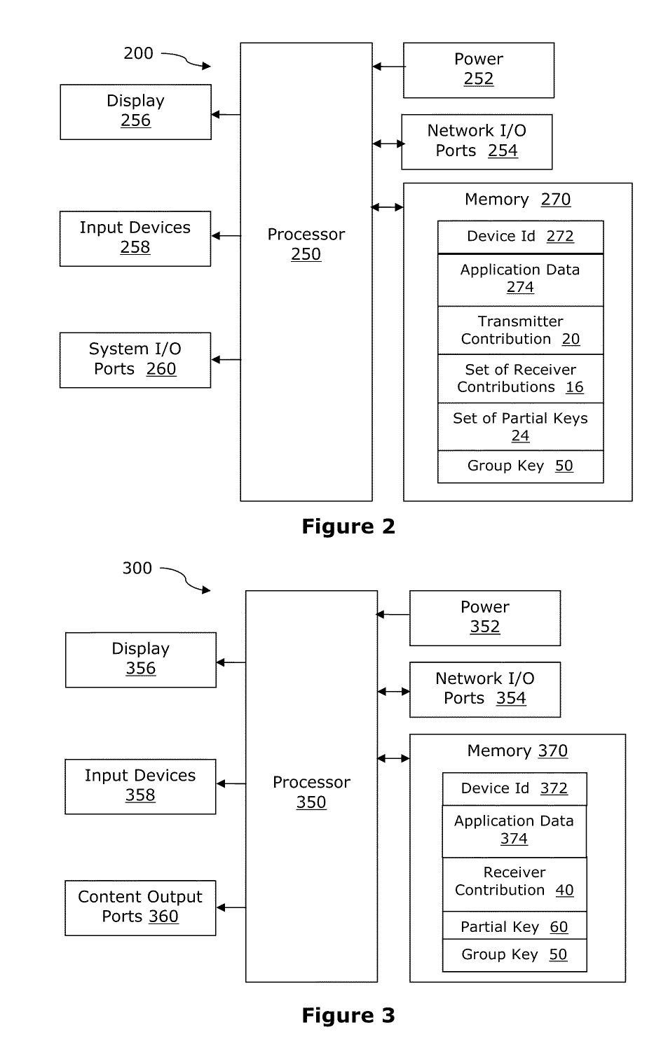

FIG. 2 illustrates a device 200 that operates as a transmitter according to the present disclosure. The device 200 comprises a processor 250 connected to a power source 252, network input and output (I/O) ports 254, a display 256, input devices 258, system I/O ports 260 and a memory 270. The processor 350 can be any conventional processor, for example a central processing unit (CPU) or a network processing unit (NPU). The power source 252 can be any conventional power source for operating the device 200. The display 256 and input devices 258 are optional components which are useful for configuring and interfacing directly with the device 200. The network I/O ports 254 permit the device 200 to connect to a plurality of receivers over a network to, amongst other things, receive encrypted key material, send partial keys and optionally to send encrypted content. The system I/O ports 260 permit the device 200 to communicate with other components forming part of a content distribution system such as a television headend. The system I/O ports 260 can, amongst other things, permit the device 200 to receive content to be encrypted by the device 200 or send the group key 50 to a real-time content encryptor to encrypt content external to the device 200. In one example embodiment, the network I/O ports 254 and the system I/O ports 260 comprise the same physical ports on the device 200.

The memory 270 can comprise volatile and non-volatile memory components such as RAM, ROM, flash memory, hard-disk memory and other kinds of memory known in the art. Memory 270 comprises the device Id 272 comprising a unique identifier for the device 200, application data 274 comprising instructions for execution in the processor 252, the transmitter contribution 20, the set of receiver contributions 16, the set of partial keys 24 and the group key 50. Access to some or all of these elements may be restricted for security purposes and some or all of these elements may only exist temporarily, or exist from time to time on the device 200. For example, for security, the device 200 may erase the transmitter contribution 20 or set of receiver contributions 16 once the group key 50 has been generated. In other example embodiments, the device 200 maintains a secure copy of the contributions to decrease computation overhead when revising the group key.

The contribution generator 12, contribution decryptor 14 and group key generator 18 may be implemented as hardware components of the device 200 such as, but not limited to, an application specific integrated chip, as software components of the application data 274 or as a combination of software and hardware as desired.

The device 200 may optionally include a content encryptor 72 in a hardware or software embodiment which receives content from the system I/O ports 262, encrypts the content using the group key 50 and distributes the encrypted content through the network I/O ports 254.

Referring to FIG. 3, another device 300 is illustrated that operates as a receiver according to the present disclosure. The device 300 comprises a processor 350, connected to a power source 352, network input and output (I/O) ports 354, a display 356, input devices 358, content output ports 360 and a memory 370. The processor 350 can be any conventional processor, for example a central processing unit (CPU) or a network processing unit (NPU). The power source 352 can be any conventional power source for operating the device 300. The display 356 and input devices 358 are optional components which are useful for configuring and interfacing directly with the device 300. The network I/O ports 354 permit the device 300 to connect to a transmitter device over a network to, amongst other things, send encrypted key material, receive a partial key and receive encrypted content. The system output ports 260 permit the device 300 to output content including encrypted content that was received and decrypted by the device 300.

The memory 370 can comprise volatile and non-volatile memory components such as RAM, ROM, flash memory, hard-disk memory and other kinds of memory known in the art. Memory 370 comprises the device Id 372 comprising a unique identifier for the device 300, application data 374 comprising instructions for execution in the processor 352, the receiver contribution 40, the partial key 60 and the group key 50. Access to some or all of these elements may be restricted for security purposes and some or all of these elements may only exist temporarily, or exist from time to time on the device 300. For example, for security, the device 300 may erase the receiver contribution 40 or partial key 60 once the group key 50 has been generated. In another embodiment, the device 300 may securely maintain a copy of the receiver contribution 40 to decrease computational overhead when revising the group key such as receiving a new partial key based on the current receiver contribution 40.

The device 300 also comprises a content encryptor 74 which receives encrypted content from the network I/O ports 354, decrypts the encrypted content using the group key 50 and distributes the content through the content output ports 360. The content encryptor 74 may be implemented in hardware such as, but not limited to, an application specific integrated chip, as software components of the application data 374 or as a combination of software and hardware as desired.

The contribution generator 32, contribution encryptor 34 and group key generator 38 also may be implemented as hardware, software or a combination thereof within device 300.

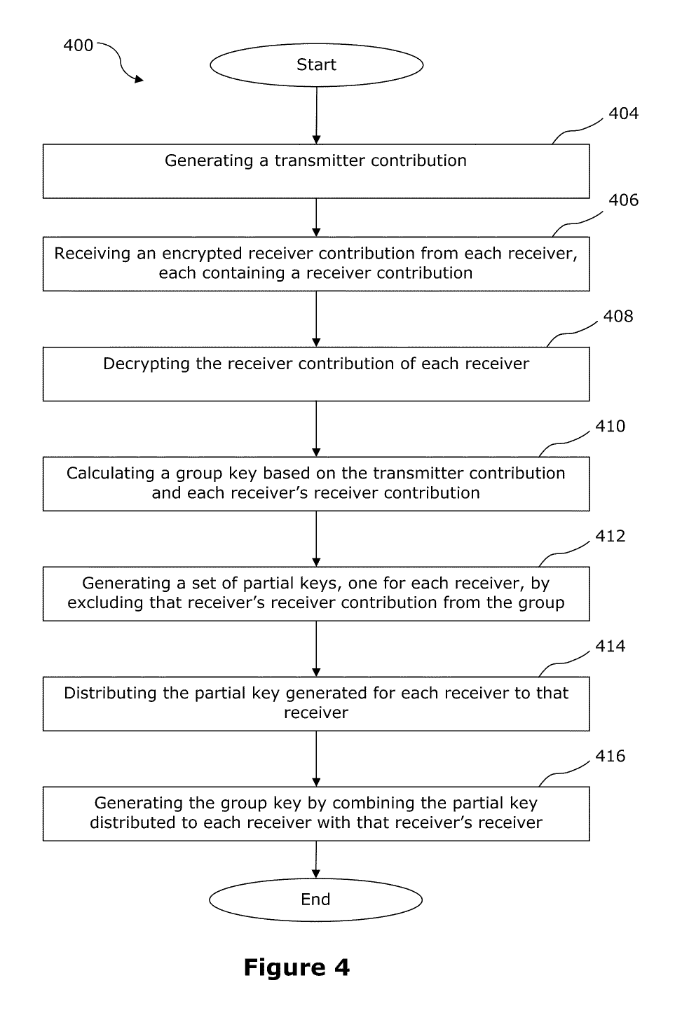

FIG. 4 illustrates a group key distribution method according to an example embodiment of the present disclosure. The method 400 distributes a cryptology key between a transmitter and a group of two or more receivers so that the key can be used to transmit encrypted content between the transmitter and receivers. At 404, the transmitter generates a transmitter contribution. This contribution may be unique to the transmitter and may be kept secret from the public. At 406, the transmitter receives, from each receiver, receiver key material containing an encrypted receiver contribution. At 408, the transmitter decrypts, from each receiver key material, the receiver contribution of that receiver. Decrypting the receiver key material may include a previously agreed upon encryption protocol between the transmitter and the receiver. The receiver contribution from each receiver may be unique and the transmitter may use such uniqueness to identify the receiver from which the contribution was sent. Other methods of identifying the source of the key material are also possible. At 410, the transmitter calculates a group key based on a transmitter contribution and the receiver contribution of each receiver. A group key is calculated from all receiver contributions and the transmitter contribution such that all receivers in the group can use the same group key and such that the transmitter can use the same group key to distribute content to all receivers in the group. At 412, the transmitter generates, for each receiver, a partial key by excluding that receiver's receiver key material from the group key. The set of partial keys comprises all partial keys generated for all receivers. Each partial key can be generated by removing the influence of that receiver's contribution from the group key. In another embodiment of the method 400, a partial key can be generated in a manner similar to generating the group key but from the transmitter contribution and the set of receiver contributions excluding the contribution of the receiver that corresponds to this partial key. At 414, the transmitter distributes, to each receiver, the partial key corresponding to that receiver via the network. At 416, by combining each receiver's partial key with that receiver's receiver contribution it is possible to generate the group key. This relationship between a partial key and its corresponding receiver's receiver contribution permits the receiver to generate a copy of the group key without revealing its contribution to the group key. When each receiver has a copy of the group key, the group key can be used for encrypted transmission of content between receivers and the transmitter.

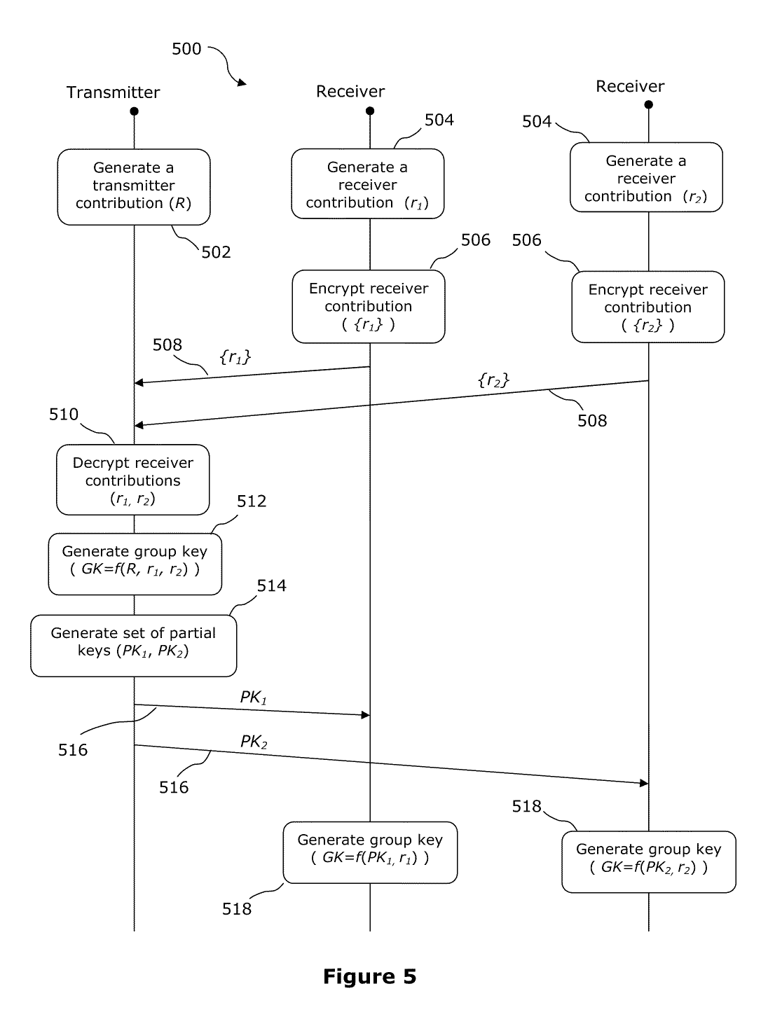

In FIG. 5, a process 500 illustrates computations and sequences of communication between devices in a message sequence diagram according to an example embodiment according to the present disclosure. The process 500 includes the computations and communications of a transmitter and a group of two receivers. At 502 and 504 the transmitter and the receivers generate a contribution (R, r₁ and r₂ respectively) to the group key GK. At 506, both receivers encrypt their receiver contributions ({r₁} and {r₂} respectively) into key material. At 508, each receiver sends its key material, in the form of its encrypted receiver contribution to the transmitter. At 510, the transmitter decrypts each received receiver key material. The encryption and decryption protocol used by the receivers and the transmitter at 506 and 510 would be agreed upon prior to the execution of process 500 such that the transmitter can decrypt the key material it receives. At 512, the transmitter generates the group key GK as a function of the contributions R, r₁ and r₂. At 514, the transmitter generates a set of partial keys, PK₁ and PK₂, one for each receiver in the group. As described above, the partial key for a receiver can be generated from the group key excluding the receiver contribution of that receiver. For example, PK₁ can be a function of GK and r₁. In another example embodiment of process 500, the partial key PK₁ can be a function of all contributions except for r₁ such that PK₁ is a function of R and r₂ in process 500. It will be understood that the computations described at 512 and 514 can be executed concurrently or independently. At 516, the transmitter distributes each partial key to its corresponding receiver, in FIG. 5 that is PK₁ to r₁ and PK₂ to r₂. At 518, each receiver calculates a copy of the group key based on the partial key it received and its receiver contribution.

It will be understood that the present disclosure may also be applied to secure group based video content sharing, bulk and stream encryptor products, improving the efficiency of PPV and virtual private network (VPN) products to enable group VPN.

It is readily apparent that the devices, systems and methods of the present disclosure are not limited to television devices, and that the devices, systems and methods may be utilized in other devices, such as handheld devices, mobile devices, etc. As well, the systems and methods may be utilized by various platforms such as Cable TV, IPTV, Mobile TV, etc. The configuration of the systems in FIGS. 1A, 1B and 1C are only example key distribution systems 100, 102 and 104, and other configurations having different variations of components may be suitable to perform the general functionality of the key distribution systems 100, 102 and 104.

While the present disclosure is described, at least in part, in terms of methods, a person of ordinary skill in the art will understand that the present disclosure is also directed to the various components for performing at least some of the aspects and features of the described processes, be it by way of hardware components, software or any combination of the two, or in any other manner. Moreover, the present disclosure is also directed to a pre-recorded storage device or other similar computer readable medium including program instructions stored thereon for performing the processes described herein.

The various embodiments presented above are merely examples and are in no way meant to limit the scope of this disclosure. Variations of the innovations described herein will be apparent to persons of ordinary skill in the art, such variations being within the intended scope of the present disclosure. In particular, features from one or more of the above-described embodiments may be selected to create alternative embodiments comprised of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the present disclosure as a whole. The subject matter described herein and in the recited claims intends to cover and embrace all suitable changes in technology. Certain adaptations and modifications of the described embodiments can be made. Therefore, the above discussed embodiments are considered to be illustrative and not restrictive.

What is claimed is:

1. A method for distributing a cryptology key between a transmitter and a group of two or more receivers connected via a network, the method comprising:
receiving, from each receiver, receiver key material, wherein each receiver key material comprises an encrypted receiver contribution;
decrypting the receiver key material from each receiver to obtain the receiver contribution of that receiver;
calculating a group key based on a transmitter contribution and the receiver contributions of all the receivers;
generating, for each receiver, a partial key by excluding that receiver's receiver contribution from the group key; and
distributing, to each receiver, the partial key corresponding to that receiver via the network,
whereby combining each receiver's partial key with that receiver's receiver contribution generates the group key.

2. The method claimed in claim 1 further including encrypting multimedia content the group key is used to encrypt television content to be transmitted to the group of receivers.

3. The method claimed in claim 1 wherein the group key is used by each receiver in the group to decrypt the encrypted multimedia content received from the transmitter.

4. The method claimed in claim 1 further comprising:
encrypting television content with the group key;
transmitting the encrypted television content to each receiver in the group; and
each receiver using the group key to decrypt the encrypted television content.

5. The method claimed in claim 1 wherein the transmitter comprises at least one of a Conditional Access Service server, a Digital Rights Management server, a television head end, and a key generation center.

6. The method claimed in claim 1 wherein a receiver device in the group comprises at least one of a television set top box (STB), a set top unit (STU), an internet protocol television (IPTV) set top and an integrated receiver/decoder (IRD).

7. The method claimed in claim 1 wherein calculating a group key based on a transmitter contribution and the receiver contribution of each receiver further comprises:
generating the group key GK in accordance with:
$$GK = {g}^{R {\prod }_{i = 1}^{n} {g}^{{r}_{i}}} ( mod p )$$
where
p is a prime number,
g is a generator of a cyclic group with prime order p;
R is the transmitter's contribution;
n is the number of receivers in the group of receivers; and
rᵢ is the receiver contribution of the i^{th} receiver.

8. The method claimed in claim 1 wherein generating, for each receiver, a partial key by excluding that receiver's receiver key material from the group key further comprises:
generating the partial key for an i^{th} receiver, PKᵢ, in accordance with:
$${PK}_{i} = {g}^{R {\prod }_{j = 1}^{n , j \neq i} {g}^{{r}_{j}}} ( mod p )$$
where
p is a prime number,
g is a generator of prime number p;
R is the transmitter's key material;
n is the number of receivers in the group of receivers; and
rⱼ is the receiver key of the j^{th} receiver.

9. A device comprising:
a processor;
a memory; and
an application stored in memory and containing instructions for configuring the processor to distribute a group key between the device and a group of two or more receivers by
generating a device contribution unique to the device;
receiving key material from each receiver in the group;
decrypting each receiver's key material to obtain a receiver contribution from each receiver;
generating the group key based on the device contribution and the receiver contributions of all receivers;
generating a partial key for each receiver, each partial key being based on the group key excluding the receiver contribution of that receiver, whereby each partial key can be combined with the receiver contribution of its corresponding receiver to generate the group key; and
sending each partial key to its corresponding receiver.

10. A device comprising:
a processor;
a memory; and
an application stored in memory and containing instructions for configuring the processor to participate in a group key generation process with a transmitter and a group of two or more receivers including the device by
generating a device contribution unique to the device;
generating key material by encrypting the device contribution;
sending the key material to the transmitter;
receiving a partial key from the transmitter; and
generating the group key based on the partial key and the device contribution.

11. A Conditional Access Service (CAS) server for distributing a cryptology key between the CAS server and a group of two or more receiver devices over a network, the CAS server comprising:
a memory for storing a CAS contribution configured to uniquely identify the CAS server, a group key and a set of partial keys;
the CAS server configured to receive receiver key material from each receiver device via the network;
a receiver contribution decryptor configured to decrypt a receiver contribution of each receiver device from the receiver key material of that receiver device and configured to store the receiver contribution in the memory;
a CAS group key generator configured to compute the group key based on the CAS contribution and each of the receiver contributions and configured to store the group key in the memory;
a CAS partial key generator configured to compute the set of partial keys, one for each receiver device, each partial key being based on the group key excluding the receiver contribution of that receiver device, whereby each partial key can be combined with the receiver contribution of its corresponding receiver to generate the group key; and
the CAS server configured to transmit each partial key to its corresponding receiver device via the network.

12. A receiver device for distributing a cryptology key between a transmitter and a group of two or more receiver devices over a network, the group including the receiver device, the receiver device comprising:
a memory for storing a receiver contribution configured to uniquely identify the receiver device from other receiver devices in the group and a group key;
a receiver contribution encryptor configured to generate receiver key material containing the receiver contribution;
the receiver device configured to transmit the receiver key material to the transmitter via the network;
the receiver device configured to receive a partial key from the transmitter via the network; and
a receiver group key generator configured to compute the group key based on the receiver contribution and the partial key and configured to store the group key in the memory.

13. The receiver device of claim 12 comprising a content decryptor for decrypting, based on the group key, encrypted television content received by the receiver.

14. A system for distributing a group key, the system comprising:
the CAS server claimed in claim 11; and
a group of two or more receivers devices connected to the CAS server over a network, wherein each of the receiver devices comprises:
a memory for storing the receiver contribution configured to uniquely identify the receiver device from other receiver devices in the group and the group key;
a receiver contribution encryptor configured to generate the receiver key material containing the receiver contribution; and
a receiver group key generator configured to compute the group key based on the receiver contribution and the partial key received by the receiver from the CAS server, and configured to store the group key in the memory.

15. The system claimed in claim 14, wherein the network comprises a television network.

16. The system claimed in claim 14, wherein the network comprises an internet protocol based architecture.
